(19) United States
(12) Patent Application Publication
(10) Pub. No.: US 2005/0255235 A1
(43) Pub. Date: Nov. 17, 2005

(54) Method of manufacturing thermosensitive recording medium

(76) Inventors: Takayuki Hiyoshi, Shizuoka (JP); Toshiyuki Tamura, Shizuoka (JP); Chiaki Tanuma, Tokyo (JP)

Correspondence Address: DLA PIPER RUDNICK GRAY CARY US LLP, P. O. BOX 9271, RESTON, VA, 20195, US

(21) Appl. No.: 11/123,143

(22) Filed: May 6, 2005

(30) Foreign Application Priority Data
May 13, 2004 (JP) P2004-143883

(51) Int. Cl. B41M 3/12

(52) U.S. Cl. 427/152

(57) ABSTRACT

A thermosensitive recording medium 1 is produced by printing a first water-dispersion thermosensitive ink by a printing method that uses a printing plate on a substrate on a surface of which an ink receptive layer impregnating the first water-dispersion thermosensitive ink is provided, and then printing a second water-dispersion thermosensitive ink using the same printing method. The first water-dispersion thermosensitive ink is prepared by dispersing a pigment that contains at least an electron-donating compound in water, and the second water-dispersion thermosensitive ink contains one or both of at least an electron-accepting compound and a sensitizer that enhances thermosensitive sensitivity. This simplifies a process for manufacturing a thermosensitive recording medium using a printing plate and reduces the manufacturing costs.

### CROSS REFERENCE TO RELATED APPLICATION

This application is based upon and claims the benefit of priority from the prior Japanese Patent Application No. 2004-143883 filed on May 13, 2004, the contents of which are incorporated herein by reference.

### BACKGROUND OF THE INVENTION

1. Field of the Invention

The present invention relates to a method of manufacturing a thermosensitive recording medium. The invention particularly relates to a method of manufacturing a multicolor thermosensitive recording medium that develops plural colors and records in high quality.

2. Description of the Related Art

There have been proposed a method of obtaining multi-color images by divisionally forming two or more thermosensitive coloring layers each developing different on a substrate and selectively applying heat over pixels of color that would be developed.

In Japanese patent application Kokai publication No. 60-208283, a multicolor recording medium is described which is formed by divisionally coating plural thermosensitive coloring materials each of which develops different color on a recording surface of a substrate and can form images of different coloring hues at each part on which thermosensitive coloring material is coated.

In Japanese patent application Kokai publication No. 2000-301835, another multicolor thermosensitive recording medium that develops divisionally different colors is described. The recording medium comprises a support, dye layers of leuco dyes having different coloring hues arranged in parallel on the support without one layer being superimposed upon another, and a developer layer or layers containing a developer that are disposed adjacent to, over and/or below the dye layers. The dye layers are provided such that multiple coloring layers having different hues are formed in stripes by reiterating a printing process of each color by printing method of screen printing, gravure printing, offset printing, etc. A high-resolution full-color image can be formed by narrowing a band of each dye layer and miniaturizing a heat-applying part of a recording head.

Forming a plurality of thermosensitive coloring layers in stripes can be achieved by coating thermosensitive inks using a coater such as blade coater, air knife coater, roll coater, bar coater, gravure coater, and lip coater when divisionally forming thermosensitive coloring layers over a substrate.

On the other hand, thermosensitive coloring layers having particular forms other than stripes, such as patterns, characters, symbols, etc. can be formed by printing methods using a relief printing plate, engraved plate, and stencil printing plate.

If ink jet printing is used as an alternate method, it is difficult to obtain a predetermined color density by one coating to form a thickness of coating that imparts a sufficient color density on a thermosensitive coloring layer. Accordingly, to obtain a predetermined thickness of coating, a number of coatings need to be performed. This complicates the working process and raises a cost of the thermosensitive recording medium. On the other hand, printing methods using a relief printing plate or engraved plate can form a predetermined thickness of coating by one coating.

As typical thermosensitive ink for producing a thermosensitive recording medium, water-dispersion thermosensitive ink is widely used in which an electron-accepting compound, for example, a developer and an electron-donating compound, for example, a pigment such as a leuco dye and sensitizer are dispersed in water using a dispersant such as a surfactant.

By coating this water-dispersion thermosensitive ink using a coater such as a blade coater, air knife coater, roll coater, bar coater, gravure coater, and lip coater, a film having a uniform thickness can be formed on a substrate.

However, when a thermosensitive coloring layer is formed by printing water-dispersion thermosensitive ink by a printing method that uses a printing plate such as a relief printing plate, engraved plate, and stencil printing plate, thickness of the printed film needs to be largely increased to obtain a fair optical density comparing to printing methods that form normal printing literatures in printing ink. The inventors of the invention confirmed that, when such a thermosensitive recording medium on which water-dispersion thermosensitive ink is thickly coated is heated to dry in an oven or others, a striped pattern is developed. This striped pattern is a phenomenon, called “streaking or streaks,” in which the water-dispersion thermosensitive ink forms a state of ‘waving’ failing to spread smoothly over the surface of the medium. This phenomenon is considered to likely occur relating to some characteristics of the water-dispersion thermosensitive ink containing a pigment.

When, using a thermosensitive recording medium having such a thermosensitive coloring layer, images are formed by applying heat energy on the medium by a thermal head, the part corresponding to the striped pattern appears as an image having uneven density, which impairs the image quality.

If an organic-solvent based thermosensitive ink that is formulated using an organic solvent in which a leuco dye and developer are dispersed is used instead of the water-dispersion thermosensitive ink, a striped pattern hardly appears. This is because the organic-solvent based thermosensitive ink that is printed holds an excellent liquid-levelling characteristic comparing to the water-dispersion thermosensitive ink. However, since an organic solvent readily dissolves substances like a developer and leuco dye used as constituents in thermosensitive ink, fogging tends to occur over a medium surface. To reduce a degree of this fogging, the kinds of usable leuco dyes and developers need to be limited. This narrows down a selectable range in kinds of materials that develop various colors, making it difficult to realize colorization. Besides, an organic-solvent based thermosensitive ink requires a high manufacturing cost.

In view of the above problems, the inventors of the present invention proposed a method of forming a thermosensitive recording medium in Japanese patent application Kokai publication No. 2004-72635 (corresponding U.S. patent application Ser. No. 10/854,413), in which the phenomenon of “streaking” can be reduced to a harmless degree by impregnating water-dispersion thermosensitive ink into a substrate and providing an ink receptive layer holding a film thickness that secures a predetermined recording density.

The inventors also proposed an idea in Japanese patent application Japanese patent application Kokai publication No. 2004-72636 (corresponding U.S. patent application Ser. No. 10/854,413), in which a sufficient color density and coloring sensitivity can be obtained by forming an auxiliary coloring layer over a thermosensitive coloring layer that is formed using a printing method.

### SUMMARY OF THE INVENTION

According to one example of the present invention, there is provided a method of manufacturing a thermosensitive recording medium comprising: a step of preparing a first water-dispersion thermosensitive ink in which a pigment containing at least an electron-donating compound is dispersed in water, a step of preparing a second thermosensitive recording medium containing one or both of an electron-accepting compound and a sensitizer that enhances thermosensitive sensitivity, a step of printing the first water-dispersion thermosensitive ink on the ink receptive layer using a predetermined printing method that uses a printing plate to impregnate the first water-dispersion thermosensitive ink into the ink receptive layer; and a step of printing by the predetermined printing method the second water-dispersion thermosensitive ink on the ink receptive layer on which the first water-dispersion thermosensitive ink is printed

### BRIEF DESCRIPTION OF THE DRAWINGS

FIG. 1 is a flowchart illustrating production of a thermosensitive recording medium according to one example of the present invention.

FIG. 2 is a diagram illustrating a process of producing a thermosensitive recording medium according to one example of the present invention.

FIG. 3 is a plan view of a thermosensitive recording medium produced according to one example of the present invention.

FIG. 4 is a sectional view taken along line A-A in FIG. 3.

FIG. 5 is a plan view showing a state of printing on the thermosensitive recording medium.

FIG. 6 is a graph showing characteristics of color development in examples 1-3 and comparative example 1.

FIG. 7 is a graph showing characteristics of color development in examples 4-6 and comparative examples 1 and 2.

FIG. 8 is a graph showing characteristics of color development in examples 7-9 and comparative example 3.

### DETAILED DESCRIPTION OF THE INVENTION

Preferred examples of the present invention will now be described in more detail with reference to the accompanying drawings. The same numerals are applied to the similar elements in the drawings, and therefore, the detailed descriptions thereof are not repeated.

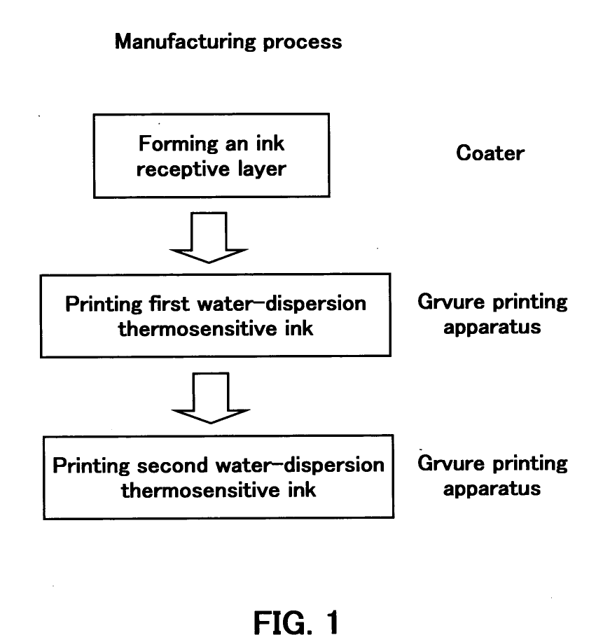

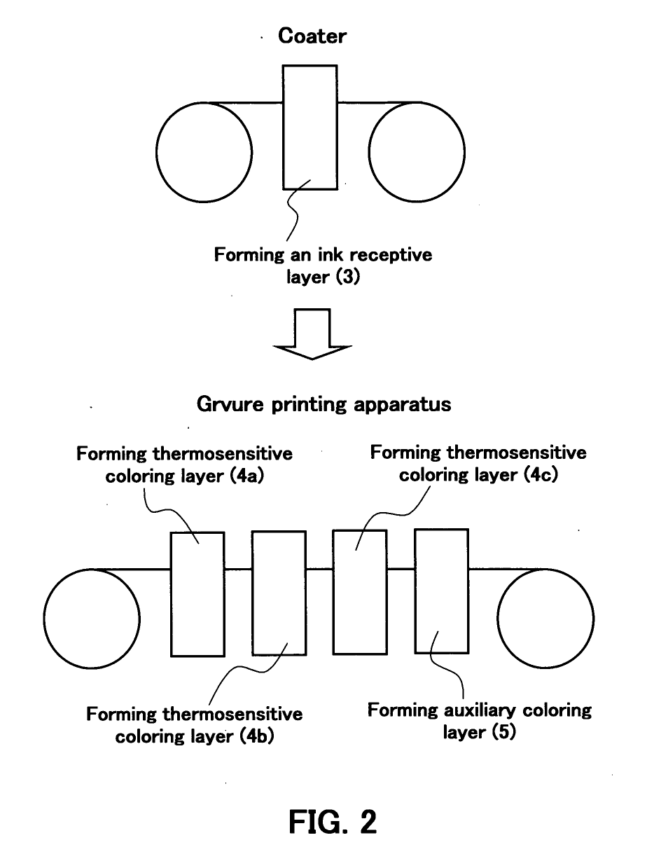

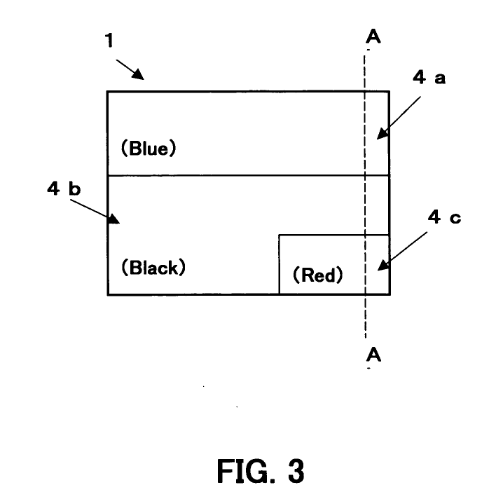

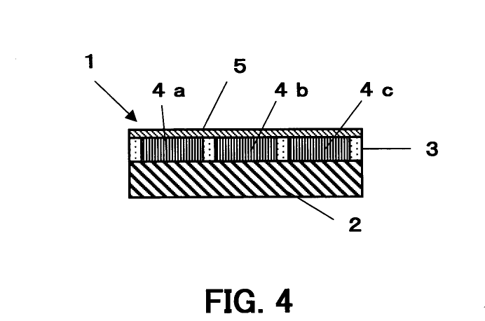

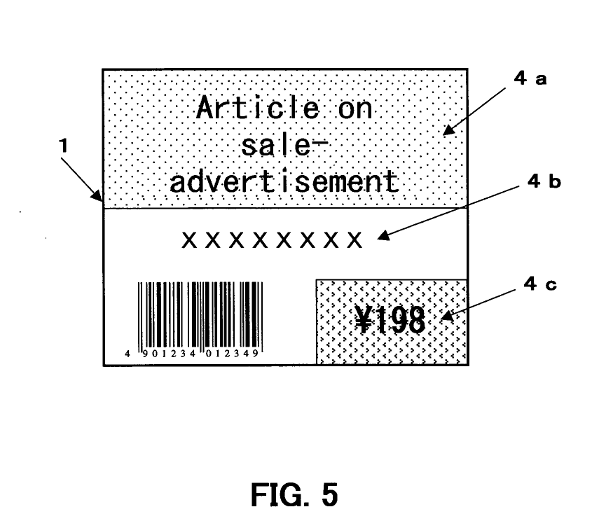

One example according to the present invention will be described in reference to FIGS. 1 through 5. FIG. 1 is a flow chart illustrating a manufacturing method of a thermosensitive recording medium. FIG. 2 illustrates a process of producing a thermosensitive recording medium. FIG. 3 is a plan view of a thermosensitive recording medium produced according to the manufacturing method of the present invention. FIG. 4 is a sectional view taken along line A-A in FIG. 3, and FIG. 5 is a plan view showing a state of printing on the medium.

To produce a thermosensitive recording medium according to the present invention, first, an ink receptive layer 3 is formed over a surface of a substrate using a coater in such an amount of coating that the weight of the coat after dried would fall in a range of 1 to 50 g/m², preferably 3 to 10 g/m². As the coater in this process, air knife coater, bar coater, roll coater, blade coater, gravure coater, etc. may be used.

Next, the first water-dispersion thermosensitive ink is printed partially on ink receptive layer 3 by printing method of flexographic printing or gravure printing that uses a relief printing plate, engraved plate, or stencil printing plate with such an amount of the ink whose weight after dried would fall in a range of 1 to 50 g/m², preferably in a range of 3 to 10 g/m², so that thermosensitive coloring layers 4a, 4b, and 4c are formed within ink receptive layer 3.

Further, an auxiliary coloring layer 5 is formed over thermosensitive coloring layers 4a, 4b, and 4c such that a second water-dispersion thermosensitive ink is coated by the same printing method, namely, same printing apparatus as used for preparing the first water-dispersion thermosensitive ink in an amount of the second water-dispersion thermosensitive ink whose weight after dried would fall in a range of 0.5 to 10 g/m², preferably in a range of 1 to 5 g/m². If necessary, a protective layer may be provided over auxiliary coloring layer 5. Also, if necessary, levelling processing may be performed using a calender or the like.

Thus forming thermosensitive coloring layers 4a, 4b, and 4c, and auxiliary coloring layer 5 using the same printing method permits use of a single printing apparatus (herein, it refers to photogravure printing machine) as shown in FIG. 2, which is able to print plural colors. This simplifies the manufacturing process of thermosensitive recording medium 1 that develops different colors and accordingly reduces its costs.

Thermosensitive recording medium 1 produced in this way is comprised of a substrate 2, ink receptive layer 3 formed on a surface of substrate 2, and thermosensitive coloring layers 4a, 4b, and 4c each developing different color from others that are formed within ink receptive layer 3, and auxiliary coloring layer 5. With this thermosensitive recording medium 1 used, different items, for example, an article on the ads, bar-code, price, etc. can be recorded in different coloring hues on the respective thermosensitive coloring layers 4a, 4b, and 4c, as shown in FIG. 5.

Substrate 2 may be of, for example, paper, plastic film of polyethylene terephthalate or the like, or metal-leaf. Materials to be used for substrate 2 are not restricted to the abovementioned, as long as they do not prevent the object of the invention from being achieved.

Ink receptive layer 3 comprises a pigment as its main component and a binder resin. Pigments usable for this layer include, for example, an inorganic pigment, such as clay, calcined clay, calcium carbonate, titanium oxide, alumina, aluminum hydroxide, silica; an organic pigment of beaded hollow resins such as styrenes, styrene-acrylics, acrylics. Also preferable for use is a porous pigment, which is formed by a mass of its primary particles, for example, a calcium carbonate or synthetic silica. More effective materials are hydrophilic pigments such as silica, alumina, titanium oxide, etc., which have been processed for surface treatment so that their pigment surfaces bear a hydroxyl group (—OH) of a hydrophilic group. Among these hydrophilic pigments, a porous pigment, for example, a hydrophilic silica that is formed by a flocculated mass of its primary particles, is even more preferable. However, materials to be used as hydrophilic pigments in this invention are not restricted to the above-mentioned, as log as they are pigments having a hydroxyl group (—OH) of a hydrophilic group and being surface-treated, preferably porous pigments formed by a flocculated mass of its primary particles, such materials can achieve the object of the present invention.

Binder resins usable for ink receptive layer 3 include water-soluble macromolecules and water-soluble macromolecule emulsions. The water-soluble macromolecules are, for example, polyvinyl alcohol, starch and its derivatives, cellulosic derivatives, gelatine, casein, styrene-dihydrogen maleic copolymer salt, styrene-acrylic acid copolymer salt. The water-soluble macromolecule emulsions include emulsions of latex of styrene-butadiene copolymer, vinyl acetate resin, styrene-acrylic ester copolymer, and polyurethane resin, etc.

As needed, a lubricant such as zinc stearate, wax, and an additive such as hindered phenols may be added to ink receptive layer 3. If the coloring density is insufficient, further an additive such as a developer may be added to it.

Ink for ink receptive layer 3 is formulated such that, first, a coating liquid is prepared by dispersing and mixing in water a hydrophilic pigment, binder resin, and some additives if need. As needed, other additive of a pigment dispersant such as sodium polyacrylate, sodium hexamethacrylate, denatured sulfonic polyvinyl alcohol, etc., a defoamer, ultraviolet absorbent, and antiseptic, etc. may be added to the liquid, as well.

The first water-dispersion thermosensitive ink contains at least an electron-donating compound and binder resin. Thermosensitive coloring layers 4a, 4b, and 4c are formed by partially printing this first water-dispersion thermosensitive ink on ink receptive layer 3 by a printing method that uses a printing plate. The respective thermosensitive coloring layers 4a, 4b, and 4c hold different coloring hues, and are formed integrally with ink receptive layer 3 within.

The electron-donating compound can use, for example, a leuco dye. To be more specific, usable as a black dye are PSD-150, PSD-184, PSD-300, PSD-802, PSD-290 of Nippon Soda Co., Ltd.; CP-101, BLACK-15, ODB, ODB2 of Yamamoto Chemicals Inc.; BLACK-100, S-205, BLACK-305, BLACK-500 of Yamada Kagaku Co., Ltd.; and TH-107 of Hodogaya Chemical Co., Ltd. Usable as a blue dye are CVL, BLUE-63, BLUE-502 of Yamamoto Chemicals Inc.; BLUE-220 of Yamada Kagaku Co., Ltd.; and BLUE-3 of Hodogaya Chemical Co., Ltd. Usable as a red dye are PSD-HR, PSD-P, PSD-O of Nippon Soda Co., Ltd.; Red-3, Red-40 of Yamamoto Chemicals Inc.; Red-500, Red-520 of Yamada Kagaku Co., Ltd.; and Vermilion-DCF, Red-DCF of Hodogaya Chemical Co., Ltd. Among the dyes indicated in the above, more than one kind may be mixed. Dyes other than black, blue, or red may also be used.

The usable binder resins are water-soluble resins such as starches, celluloses, polyvinyl alcohols, and resin latexes such as polyvinyl acetate, polyurethane, polyacrylic ester. These materials may be mixed for the use, as well.

The first water-dispersion ink is prepared by first dispersing and mixing in water a leuco dye (electron-donating compound), binder resin, and pigments such as a sensitizer if necessary, printhead abrasion resistance agent, anti-sticking agent, developer (electron-accepting compound), and adjusting physical properties of the ink such as viscosity and surface tension suitable to the printing apparatus being used. During this process, if needed, various additives such as a modified resin, such as denatured sulfonic polyvinyl alcohol, dispersant such as a surfactant, defoamer, ultraviolet absorbent, and antiseptic may be mixed in the ink.

The second water-dispersion thermosensitive ink contains one or both of an electron-accepting compound and sensitizer enhancing coloring sensitivity. This second water-dispersion thermosensitive ink is printed on thermosensitive coloring layers 4a, 4b, and 4c by means of the same printing method, that is, printing apparatus as used for preparing the first water-dispersion thermosensitive ink, so that an auxiliary coloring layer 5 is formed.

For the electron-accepting compound, a developer can be used. To be more specific, oxides such as phenols, phenolic metallic salts, carboxylic metallic salts, sulfonic acid, sulfonate, phosphoric acid, phosphoric metallic salts, acid ester phosphate, phosphorous acids, phosphorous acid metallic salts may be used. These materials may be used either alone or mixed as well.

Although an ideal material for the sensitizer differs depending on an electron-accepting compound and electron-donating compound that are used, for example, a sensitizer HS-3520, manufactured by Dainippon Ink & Chemicals Co., Ltd. may be used.

For the binder resins, the same binder resins described relating to the first water-dispersion thermosensitive ink can be used. They are, for example, water-soluble resins such as starches, celluloses, polyvinyl alcohols, and resin latex resins such as polyvinyl acetate, polyurethane, polyacrylic ester. These materials may be used either alone or mixed as well.

As needed, printhead abrasion resistance agents and anti-sticking agents, such as zinc stearate, amide stearate, or calcium carbonate may be used.

The second water-dispersion thermosensitive ink is formulated by first dispersing and mixing in water one or both of an electron-accepting compound (for example, developer) and a sensitizer with a binder resin, and then adjusting physical property such as viscosity and surface tension according to printing apparatus used. In this process, if needed, a modified resin such as denatured sulfonic polyvinyl alcohol, dispersant such as surfactant, various additives such as defoamer, ultraviolet absorbent, antiseptic, etc. may also be added to the ink.

### EXAMPLES

Hereinafter, specific compositions of thermosensitive recording medium 1 according to the present invention will be described by using examples. However, the invention is not restricted to such examples. In the examples below, unit “part(s)” means “part(s) by weight.”

### Example 1

Formation of Ink receptive Layer

| | |
|---|---|
| Calcined kaolin (pigment in the ink receptive layer) | 100 parts |
| (KAOCAL (brand name), available from Shiraishi | |
| Kogyo Kaisha Ltd.) | |
| Hydrophilic silica (pigment in the ink receptive layer) | 11 parts |
| (Nipsil E-220A (brand name), manufactured | |
| by Tosoh Silica Corp.) | |
| Sodium polyacrylate (dispersant) | 1 part |
| Water | 280 parts |

A pigment dispersion liquid of hydrophilic silica was prepared by dispersing the above components using a homogenizer. Then, a coating liquid for ink receptive layer 3 was prepared by adding the following components to this pigment dispersion liquid.

| | |
|---|---|
| Styrene-butadiene copolymer latex | 55 parts |
| (48%-SBR dispersion liquid, manufactured by JSR) | |
| Phosphate ester starch | 37 parts |
| (MS-4600 (20% aqueous solution), manufactured | |
| by Nihon Shokuhin Kako Co., Ltd.) | |

An ink receptive layer 3 was formed on substrate 2 (quality paper) having a weight of 65 g/m² by coating with a bar coater the coating liquid prepared in the above in such an amount that the coating after dried would weigh 8 g/m².

Printing of the first water-dispersion thermosensitive ink

| | |
|---|---|
| Leuco dye dispersion liquid (30% of solid composition) | 50 parts |
| Blue (CVL, manufactured by Yamamoto Chemicals Inc.) | |
| Black (ODB-2, manufactured by Yamamoto Chemicals Inc.) | |
| Red (Vermilion-DCF, manufactured by Hodogaya Chemical | |
| Co., Ltd.) | |

Leuco dye dispersion liquids were prepared by dipersing leuco dyes in water with a 5% dispersant of GOHSERAN L-3266 (manufactured by The Nippon Synthetic Chemical Industry Co., Ltd.) and using a sand mill to obtain an average particle size of 0.8 μm.

| | |
|---|---|
| Developer dispersion liquid (40% of solid composition) | 75 parts |
| (D-8 manufactured by Nippon Soda Co., Ltd.) | |
| (F-647 (dispersion liquid using D-8) manufactured by | |
| Chukyo Yushi Co., Ltd.) | |
| Sensitizer dispersion liquid (30% of solid composition) | 100 parts |
| (HS-3520, manufactured by Dainippon Ink & Chemicals | |
| Co., Ltd.) | |

This sensitizer dispersion liquid was prepared by dispersing the sensitizer as a dispersant with a 5% GOHSERAN L-3266 (manufactured by The Nippon Synthetic Chemical Industry Co., Ltd.) and using a sand mill so as to obtain an average particle size of 0.8 μm.

| | |
|---|---|
| Lubricant dispersion liquid (30% of solid composition) | 32 parts |
| (Zinc stearate: HIDRIN Z-7-30, manufactured by | |
| Chukyo Yushi Co., Ltd.) | |
| Recrystalization-inhibitor dispersion liquid (35% of | 20 parts |
| solid composition) DH43, manufactured by | |
| Asahi Denka Co., Ltd. | |
| HYDRIN F-165 manufactured by Chukyo Yushi Co., Ltd. | |
| Calcium carbonate dispersion liquid (30% of | 50 parts |
| solid component) (KARURAITO-KT, manufactured | |
| by Shiraishi Central Laboratories) | |

A calcium carbonate dispersion liquid was prepared by dispersing the sensitizer as a dispersant with a 5% GOHSERAN L-3266 (manufactured by The Nippon Synthetic Chemical Industry Co., Ltd.) and using a sand mill so as to obtain an average particle size of 0.8 μm.

| | |
|---|---|
| 10%-PVA solution | 53 parts |
| (PVA110, manufactured by Kralle Co., Ltd.) | |
| Surfactant (10% of solid composition) | 33 parts |
| (ADEKACOL EC4500, manufactured | |
| by Asahi Denka Co., Ltd.) | |
| Water | 25 parts |

The first water-dispersion thermosensitive inks having different color hues of blue, black, and red were formulated by mixing the above developer dispersion liquid, sensitizer dispersion liquid, lubricant dispersion liquid, recrystalization-inhibitor dispersion liquid, calcium carbonate dispersion liquid, 10%-PVA solution, surfactant, and water with the respective leuco dye dispersion liquids of blue, black, and red.

Each of the first water-dispersion thermosensitive inks prepared in the above process was adjusted so that the viscosity falls in a range between 30 and 40 cps (measured with an E type viscometer of Tokyo Keiki Co., Ltd.) and the surface tension becomes 30 m N/m or lower (measured with a K12-Mk5 surface tension balance, manufactured by Kruss GmbH). Lowering the surface tension of the ink using a surfactant is needed, particularly when printing using an engraved plate, since the ink having a high surface tension makes it difficult to let the ink intrude into an engraved plate.

This first water-dispersion thermosensitive ink was printed on ink receptive layer 3 using a simplified photogravure printing machine (K Printing Proofer, available from Matsuo Sangyo Co., Ltd.), equipped with an etched plate having 150 lines in cell density and 40 μm in cell depth, so that thermosensitive recording medium 1 (before forming auxiliary coloring layer 5) as in FIG. 3 was produced. In this thermosensitive recording medium 1, 4a denotes a thermosensitive coloring layer developing blue, 4b is a thermosensitive coloring layer developing black, and 4c is a thermosensitive coloring layer developing red.

Printing of the second water-dispersion

| | |
|---|---|
| Developer dispersion liquid (40% of solid composition) | 37.5 parts |
| (D-8 (developer), manufactured by Nippon Soda Co., Ltd.) | |
| (F-647 (dispersion liquid using D-8), manufactured | |
| by Chukyo Yushi Co., Ltd.) | |
| Binder resin solution (30% of solid component) | 2.5 parts |
| (BI-103 (brand name), manufactured by Harima | |
| Chemicals, Inc.) | |
| Water | 117.5 parts |
| Surfactant (10% of solid composition) | 8.7 parts |
| (ADEKACOL EC4500, manufactured by | |
| Asahi Denka Co., Ltd.)9 g) | |

Auxiliary coloring layer 5 was formed such that the second water-dispersion ink formulated in the above process was printed over thermosensitive coloring layers 4 (4a, 4b, 4c) using a simplified photogravure printing machine (K Printing Proofer, available from Matsuo Sangyo Co., Ltd.), that is equipped with an etched plate having 175 lines in cell density and 34 μm in cell depth.

To observe condition of the printing, the produced thermosensitive recording medium 1 was held in an oven at 130 degree C. for five minutes so that thermosensitive coloring layers 4a, 4b, and 4c developed respective colors. Although “Streaking” was somewhat seen during the printing, a striped pattern by “Streaking” did not appear, and nearly uniform printing surface was obtained.

Next, a protective layer was formed over auxiliary coloring layer 5 by coating OCA-5, manufactured by Nippon Kayaku Co., Ltd., with a bar coater in such an amount that the coating after dried would weigh 1 g/m², so that a medium sample (the thermosensitive recording medium in example 1) was obtained. After images were recorded as shown in FIG. 5 on this medium sample using a barcode printer KP-50 of Toshiba Tec K. K., the recordings appeared without causing irregular color density in the recorded part.

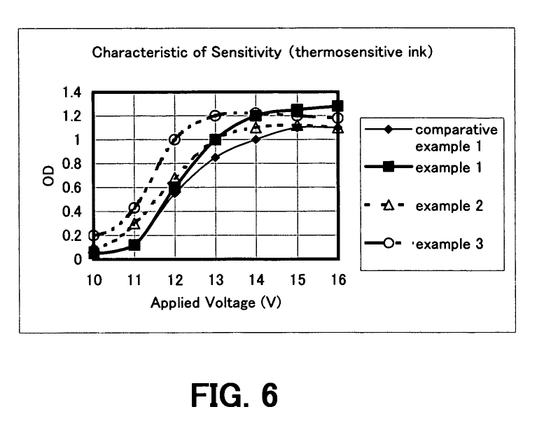

The recorded images on this medium sample was evaluated in respect to coloring sensitivity and OD value (color density) using a thermal printhead, type KBE-56-8MGK1 manufactured by Kyocera Corporation, by setting a printing period to 5 msec/line, duty cycle to 70%, and changing an applied voltage in a range of 10 and 16 volts in unit of 1 volt. The measurements result is shown in FIG. 6.

Streaking in printing on thermosensitive coloring layers 4a, 4b, and 4c was in an unquestionable degree, since the medium was provided with ink receptive layer 3. Although, as to the coloring sensitivity, almost no difference was observed between this example and comparative example 1 that will be described later, the color density has improved and void has diminished due to the developer added to auxiliary coloring layer 5. The evaluation was applied to the part of thermosensitive coloring layer 4b that develops black. Comparative example 1 (to be described later) differs from this example 1 wherein the former lacks auxiliary coloring layer 5, otherwise they are the same. Although the coloring sensitivity in this example 1 showed more or less the same as that in comparative example 1, the saturation density in this example has improved by a degree of 0.2. It is considered that, because auxiliary coloring layer 5 containing a developer is provided, the developer contained in auxiliary coloring layer 5 has contributed to the color development in thermosensitive coloring layers 4a, 4b, and 4c, such that much of the developer that was added to auxiliary coloring layer 5 resides on the surface (heat-applied side) of thermosensitive coloring layers 4 without deeply penetrating into ink receptive layer 3.

### Example 2

In example 1, auxiliary coloring layer 5 was formed by adding a developer to the second water-dispersion thermosensitive ink. In this example 2, a sensitizer, which contributes to improving thermal sensitivity of thermosensitive coloring layers 4 instead of the developer, was added to auxiliary coloring layer 5. The structure of the medium otherwise remain the same as in example 1. That is, ink receptive layer 3 as described in example 1 is formed on substrate 2, then thermosensitive coloring layers 4 were formed on the ink receptive layer 3 by printing the first water-dispersion thermosensitive ink of each color as described in example 1 using a simplified photogravure printing machine (K Printing Proofer, available from Matsuo Sangyo Co., Ltd.), which is equipped with an etched plate having 175 lines in cell density and 34 μm in cell depth. Subsequently, the following auxiliary coloring layer 5 was formed over the layers using the second water-dispersion thermosensitive ink as described below.

Printing of the second water-dispersion thermosensitive ink

| | |
|---|---|
| Sensitizer dispersion liquid (30% of solid composition) | 50 parts |
| (HS-3520, manufactured by Dainippon | |
| Ink & Chemicals Co., Ltd.) | |

This sensitizer dispersion liquid was prepared such that, with 5% of GOHSERAN L-3266 (manufactured by The Nippon Synthetic Chemical Industry Co., Ltd.) as a dispersant, the sensitizer was dipersed in water using a sand mill so as to get an average particle size of 0.8 μm.

| | |
|---|---|
| Binder resin solution (30% of solid component) | 2.5 parts |
| (BI-103 (brand name), manufactured by | |
| Harima Chemicals, Inc.) | |
| Water | 105 parts |
| Surfactant (10% of solid composition) | 8.7 parts |
| (ADEKACOL EC4500, manufactured by | |
| Asahi Denka Co., Ltd.) | |

Auxiliary coloring layer 5 was formed such that the second water-dispersion ink formulated in the above process was printed over thermosensitive coloring layers 4 (4a, 4b, 4c) by a simplified photogravure printing machine (K Printing Proofer, available from Matsuo Sangyo Co., Ltd.), that is equipped with an etched plate having 175 lines in cell density and 34 μm in cell depth.

To observe condition of the printing, the produced thermosensitive recording medium 1 was held in an oven at 130 degree C. for five minutes so that thermosensitive coloring layers 4a, 4b, and 4c developed respective colors. Although “Streaking” was somewhat seen during printing, a striped pattern by “Streaking” did not appear, and nearly uniform printing surface was obtained.

Next, a protective layer was formed over auxiliary coloring layer 5 by coating OCA-5, manufactured by Nippon Kayaku Co., Ltd., with a bar coater in such an amount that the coating after dried would weigh 1 g/m², so that a medium sample (thermosensitive recording medium of example 2) was obtained. On this medium sample, images were recorded as shown in FIG. 5 using a barcode printer KP-50 of Toshiba Tec K. K. As a result, the recordings appeared without causing irregular color density in the recorded part.

Using the thermosensitive recording medium 1 produced in this example 2, coloring sensitivity and color density of the thermosensitive coloring layer 4 b (black) were measured as in examples 1. The measurements result is shown in FIG. 6. As seen in the FIGURE, comparing to comparative example 1 (auxiliary coloring layer 5 was not formed) which will be described later, there was no change on the saturation density. It can be seen that the coloring sensitivity has improved (a color density of the same degree was obtained even if the voltage applied to the thermal printhead was lowered by 1 volt). This is due to the addition of a sensitizer to the auxiliary coloring layer 5, more specifically because the sensitizer contained in the auxiliary coloring layer 5 was present on a surface of thermosensitive coloring layer 4 without penetrating deeply into ink receptive layer 3.

### Example 3

In example 1, auxiliary coloring layers 5 was formed by adding a developer to the second water-dispersion thermosensitive ink, while in example 2 a sensitizer was added to the second water-dispersion thermosensitive ink to form auxiliary coloring layers 5. In this example 3, both of a developer and sensitizer are added to the second water-dispersion thermosensitive ink, and the structure otherwise remains the same as in examples 1 and 2. That is, first, ink receptive layer 3 as described in example 1 was formed on substrate 2, then thermosensitive coloring layers 4 was formed over this ink receptive layer 3 by printing the first water-dispersion thermosensitive ink of each color as described in example 1 using a simplified photogravure printing machine (K Printing Proofer, available from Matsuo Sangyo Co., Ltd.), which is equipped with an etched plate having 175 lines in cell density and 34 μm in cell depth. Finally, over this thermosensitive coloring layers 4, auxiliary coloring layer 5 was formed using the second water-dispersion thermosensitive ink, which will be described below.

Printing of the second water-dispersion thermosensitive ink

| | |
|---|---|
| Developer dispersion liquid (40% of solid composition) | 37.5 parts |
| (D-8 (developer), manufactured by Nippon Soda Co., Ltd.) | |
| (F-647 (dispersion liquid using D-8), manufactured | |
| by Chukyo Yushi Co., Ltd.) | |
| Sensitizer dispersion liquid (30% of solid composition) | 50 parts |
| (HS-3520, manufactured by Dainippon Ink & | |
| Chemicals Co., Ltd.) | |

This sensitizer dispersion liquid was prepared by dispersing the sensitizer as a dispersant with a 5% GOHSERAN L-3266 (manufactured by The Nippon Synthetic Chemical Industry Co., Ltd.) and using a sand mill so as to obtain an average particle size of 0.8 μm.

| | |
|---|---|
| Binder resin solution (30% of solid component) | 5 parts |
| (BI-103 (brand name), manufactured by | |
| Harima Chemicals, Inc. | |
| Water | 222.5 parts |
| Surfactant (10% of solid composition) | 8.7 parts |
| (ADEKACOL EC4500, manufactured by | |
| Asahi Denka Co., Ltd.) | |

Auxiliary coloring layer 5 was formed such that the second water-dispersion ink formulated in the above process was printed over thermosensitive coloring layers 4 (4a, 4b, 4c) by a simplified photogravure printing machine (K Printing Proofer, available from Matsuo Sangyo Co., Ltd.), that is equipped with an etched plate having 175 lines in cell density and 34 μm in cell depth.

To observe condition of the printing, the produced thermosensitive recording medium 1 was held in an oven at 130 degree C. for five minutes so that thermosensitive coloring layers 4a, 4b, and 4c developed respective colors. Although “Streaking” was somewhat seen during printing, a striped pattern by “Streaking” did not appear, and nearly uniform printing surface was obtained.

Next, a protective layer was formed over auxiliary coloring layer 5 by coating OCA-5, manufactured by Nippon Kayaku Co., Ltd., with a bar coater in such an amount that the coating after dried would weigh 1 g/m², so that a medium sample (thermosensitive recording medium of example 3) was obtained. On this medium sample, images were recorded as shown in FIG. 5 using a barcode printer KP-50 of Toshiba Tec K. K. As a result, the recordings appeared without causing irregular color density in the recorded part.

Using the thermosensitive recording medium 1 produced in this example 3, coloring sensitivity and color density of the thermosensitive coloring layer 4 b (black) were measured as in examples 1 and 2. The measurements result is shown in FIG. 6. As seen in FIG. 6, comparing to comparative example 1 (an auxiliary coloring layer 5 is not provided therein) which will be described later, the saturation density improved by some 0.2 by virtue of the developer, while the sensitivity improved by some 2 volts by effect of the sensitizer. The improvements in the color density and coloring sensitivity are considered to be made because the developer and sensitizer added to the auxiliary coloring layer 5 were present on a surface of thermosensitive coloring layer 4 without penetrating deeply into ink receptive layer 3.

### Comparative Example 1

Comparative example 1 used thermosensitive recording medium 1 wherein auxiliary coloring layer 5 was not provided unlike thermosensitive recording medium 1 in example 1 (or examples 2, 3) which incorporates auxiliary coloring layer 5 as described earlier. That is, in this example the second water-dispersion thermosensitive ink was not printed. Using the thermosensitive recording medium produced in this comparative example, coloring sensitivity and color density of thermosensitive coloring layer 4b (black) were measured as in examples 1 through 3. The measurements result is shown in FIG. 6. In this comparative example 1, since auxiliary coloring layer 5 was not provided in the medium, the saturation voltage applied to a thermal printhead was between 14 and 15 volts, and the saturation density was 1.08. It can be seen that the thermosensitive recording medium in this comparative example 1 exhibited low either in saturation density or coloring sensitivity, comparing to those in examples 1 through 3. The reason for this is considered that only part of the water-dispersion thermosensitive ink that resides on a surface of the ink receptive layer 3 in a total amount of the ink penetrated into ink receptive layer 3 has contributed to the color development.

### Example 4

Thermosensitive recording medium 1 used in this example 4 differs from example 1 in respect to the structure of ink receptive layer 3, other structures and production process are the same as that of example 1.

Formation of Ink Receptive Layer

| | |
|---|---|
| Calcined kaolin (pigment in ink receptive layer 3) | 100 parts |
| (KAOCAL (brand name), available from | |
| Shiraishi Kogyo Kaisha Ltd.) | |
| Hydrophilic silica (pigment in ink receptive layer 3) | 11 parts |
| (Nipsil E-220A (brand name), manufactured | |
| by Tosoh Silica Corp.) | |
| Dispersant: Sodium polyacrylate | 1 part |
| Water | 318 parts |

A pigment dispersant liquid of hydrophilic silica was prepared by dispersing the above compositions using a homogenizer. Then, by adding and dispersing the following components to the pigment dispersion liquid prepared, a coating liquid of ink receptive layer 3 was prepared.

| | |
|---|---|
| Styrene-butadiene copolymer latex | 56 parts |
| (48%-SBR dispersion liquid, manufactured by JSR) | |
| Phosphate ester starch | 37 parts |
| (MS-4600 (20% aqueous solution), manufactured | |
| by Nihon Shokuhin Kako Co., Ltd.) | |
| Developer dispersion liquid (40% of solid composition) | 97 parts |
| (D-8 (developer), manufactured by Nippon Soda Co., Ltd. | |
| F-647 (dispersion liquid using D-8), manufactured | |
| by Chukyo Yushi Co., Ltd.) | |
| Lubricant dispersion liquid (30% of solid composition) | 41 parts |
| (Zinc stearate: HIDRIN Z-7-30 (brand name), manufactured by | |
| Chukyo Yushi Co., Ltd.) | |
| Recrystalization-inhibitor dispersion liquid | 26 parts |
| (35% of solid composition) | |
| (DH43 (recrystalization-inhibitor), manufactured | |
| by Asahi Denka Co., Ltd. | |
| (HYDRIN F-165 (recrystalization-inhibitor dispersion liquid), | |
| manufactured by Chukyo Yushi Co., Ltd.) | |

Ink receptive layer 3 was formed on substrate 2 such that this coating liquid was coated with a bar coater on substrate 2 (quality paper) having a weight of 65 g/m² in such an amount that the coating after dried would weigh 8 g/m². Other structures of the thermosensitive recording medium 1 of example 4, that is, those of thermosensitive coloring layers 4 and auxiliary coloring layer 5 in this example 4 are the same as those in example 1. This thermosensitive recording medium 1 was produced such that, first, thermosensitive coloring layers 4 were formed such that the first water-dispersion thermosensitive inks in example 1 were printed on ink receptive layer 3 using a simplified photogravure printing machine (K Printing Proofer, available from Matsuo Sangyo Co., Ltd.), equipped with an etched plate having 175 lines in cell density and 34 μm in cell depth; then, auxiliary coloring layer 5 (one containing a developer) was formed on the thermosensitive coloring layers 4 formed in the above by printing the same second water-dispersion thermosensitive ink as in example 1 using a simplified photogravure printing machine (K Printing Proofer, available from Matsuo Sangyo Co., Ltd.) with an etched plate having 175 lines in cell density and 34 μm in cell depth; and, a protective layer was formed over the auxiliary coloring layer 5 formed in the above by coating OCA-5, manufactured by Nippon Kayaku Co., Ltd., using a bar coater over the layer in such an amount that the coating after dried would weigh 1 g/m². After images were recorded as shown in FIG. 5 on this medium sample using a barcode printer KP-50 of Toshiba Tec K. K., the recordings appeared without causing irregular color density in the recorded part.

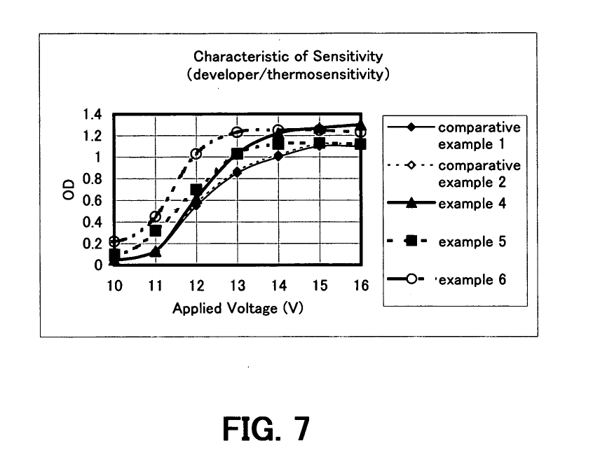

Using the thermosensitive recording medium 1 produced in this example 4, coloring sensitivity and color density of the thermosensitive coloring layer 4 b (black) were measured as in examples 1 though 3. The measurements result is shown in FIG. 7. Comparative example 2 (described later) differs from example 4 in respect that an auxiliary coloring layer is not provided therein, they are otherwise the same. Comparing to comparative example 2, the saturation density in example 4 improved by some 0.2 as in example 1, although the coloring sensitivity did not changed so much. This improvement is considered to be made by the same reason as in example 1. The color density became greater than example 1 because a developer is contained also in ink receptive layer 3.

### Example 5

This example used ink receptive layer 3 as described in example 4. Otherwise, the structure remained the same as in example 2. That is, the thermosensitive recording medium 1 in this example 5 was produced such that, first, thermosensitive coloring layers 4 were formed such that the first water-dispersion thermosensitive inks used in examples 1 through 3 were printed over the ink receptive layer 3 (one containing a developer) as described in example 4 using a simplified photogravure printing machine (K Printing Proofer, available from Matsuo Sangyo Co., Ltd.), equipped with an etched plate having 175 lines in cell density and 34 μm in cell depth; next, the auxiliary coloring layer 5 (one containing a developer) was formed over the above-mentioned thermosensitive coloring layers by printing the second water-dispersion thermosensitive ink as described in example 2 using a simplified photogravure printing machine (K Printing Proofer, available from Matsuo Sangyo Co., Ltd.) with an etched plate having 175 lines in cell density and 34 μm in cell depth; last, a protective layer was formed over the above-mentioned auxiliary coloring layer by coating OCA-5, manufactured by Nippon Kayaku Co., Ltd., with a bar coater over the layer in such an amount that the coating after dried would weigh 1 g/m². After images were recorded as shown in FIG. 5 on this medium sample using a barcode printer KP-50 of Toshiba Tec K. K., the recordings appeared without causing irregular color density in the recorded part.

Using the thermosensitive recording medium 1 produced in this example 5, coloring sensitivity and color density of thermosensitive coloring layer 4b were measured as in examples 1 through 4. The measurements result is shown in FIG. 7. The medium in this example 5, comparing to one in comparative example 2 (will be described later), the coloring sensitivity improved to such a degree that the same degree of coloring density was obtained even if the voltage applied to the thermal printhead was lowered by some 1 to 2 volts, as in example 2, while the saturation density did not change so much. The reason for this is considered to be same as in example 2.

### Example 6

This example 6 used the ink receptive layer 3 described in example 4. Otherwise, the structure remained the same as in example 3. That is, the thermosensitive recording medium 1 in this example was produced such that; first, thermosensitive coloring layers 4 were formed such that, first, the first water-dispersion thermosensitive inks used in examples 1 through 3 were printed on the ink receptive layer 3 (one containing a developer) as described in example 4, using a simplified photogravure printing machine (K Printing Proofer, available from Matsuo Sangyo Co., Ltd.), equipped with an etched plate having 175 lines in cell density and 34 μm in cell depth; next, auxiliary coloring layer 5 (one containing a developer and sensitizer) was formed by printing the second water-dispersion thermosensitive ink described in example 3 over the above-mentioned thermosensitive coloring layers, using a simplified photogravure printing machine (K Printing Proofer, available from Matsuo Sangyo Co., Ltd.), equipped with an etched plate having 175 lines in cell density and 34 μm in cell depth; last, a protective layer was formed over the above-mentioned auxiliary coloring layer by coating OCA-5, manufactured by Nippon Kayaku Co., Ltd., with a bar coater over the layer in such an amount that the coating after dried would weigh 1 g/m². After images were recorded as shown in FIG. 5 on this medium sample using a barcode printer KP-50 of Toshiba Tec K. K., the recordings appeared without causing irregular color density in the recorded part.

Using the thermosensitive recording medium 1 produced in this example 6, coloring sensitivity and color density of thermosensitive coloring layer 4b were measured as in examples 1 through 5. The measurements result is shown in FIG. 7. It can be seen that the medium in this example has improved in respect to both the coloring sensitivity and color density, comparing to one in comparative example 2 (will be described later). The reason for this is considered to be same as in example 3.

### Comparative Example 2

This comparative example 2 used a thermosensitive recording medium wherein auxiliary coloring layer 5 was not provided in thermosensitive recording medium 1 of example 4 (or examples 5 and 6), as described earlier. That is, in this example the second water-dispersion thermosensitive ink was not printed. Using the thermosensitive recording medium 1 produced in this comparative example 2, coloring sensitivity and color density of thermosensitive coloring layer 4b (black) were measured as in examples 4 through 6. The measurements, together with those of the aforementioned comparative example 1, are shown in FIG. 7. It can be seen that the sensitivity and color density in nearly the same degrees as those in comparative example 1 were gained even if a developer was added to the ink receptive layer 3. The reason for this is presumed that the developer residing deeply inside the ink receptive layer 3 has not much contributed to the color development.

### Example 7

Thermosensitive recording medium 1 in this example is the same as that in example 4 except for a structure of thermosensitive coloring layer 4, that is, the first water-dispersion thermosensitive ink. In example 4, a developer was added to the ink receptive layer 3.

Printing of the first water-dispersion thermosensitive ink

15d) Water-Dispersion Ink

| | |
|---|---|
| Leuco dye dispersion liquid (30% of solid composition) | 50 parts |
| Blue (CVL, manufactured by Yamamoto Chemicals Inc.) | |
| Black (ODB-2, manufactured by Yamamoto Chemicals Inc.) | |
| Red (Vermilton-DOF, manufactured by Hodogaya Chemical | |
| Co., Ltd.) | |

Leuco dye dispersion liquids were prepared by dispersing leuco dyes in water with a 5% GOHSERAN L-3266 (manufactured by The Nippon Synthetic Chemical Industry Co., Ltd.) and using a sand mill so as to obtain an average particle size of 0.8 μm.

| | |
|---|---|
| BI-103 (30% of solid composition), manufactured by | 3 parts |
| Harima Chemicals, Inc. | |
| Surfactant (10% of solid composition) | 1 part |
| ADEKACOL EC4500, manufactured by Asahi Denka Co., Ltd. | |

First water-dispersion thermosensitive inks having different coloring hues of blue, black, and red were prepared by mixing the BI-103 liquid and surfactant in the respective leuco dye dispersion liquids above-mentioned of blue, black, and red.

In this example 7, thermosensitive recording medium 1 was produced such that, first, thermosensitive coloring layer 4 was formed such that the water-dispersion ink of each color prepared in the above was printed over ink receptive layer 3 described in example 4 using a simplified photogravure printing machine (K Printing Proofer, available from Matsuo Sangyo Co., Ltd.), equipped with an etched plate having 175 lines in cell density and 34 μm in cell depth; next, auxiliary coloring layer 5 was formed by printing the same second water-dispersion thermosensitive ink as in example 4 over the above-mentioned layer, using a simplified photogravure printing machine (K Printing Proofer, available from Matsuo Sangyo Co., Ltd.), equipped with an etched plate having 175 lines in cell density and 34 μm in cell depth; then, a protective layer was formed over the auxiliary coloring layer 5 by coating OCA-5, manufactured by Nippon Kayaku Co., Ltd., over the layer with a bar coater in such an amount that the coating after dried would weigh 1 g/m². After images were recorded as shown in FIG. 5 on this medium sample using a barcode printer KP-50 of Toshiba Tec K. K., the recordings appeared without causing irregular color density in the recorded part.

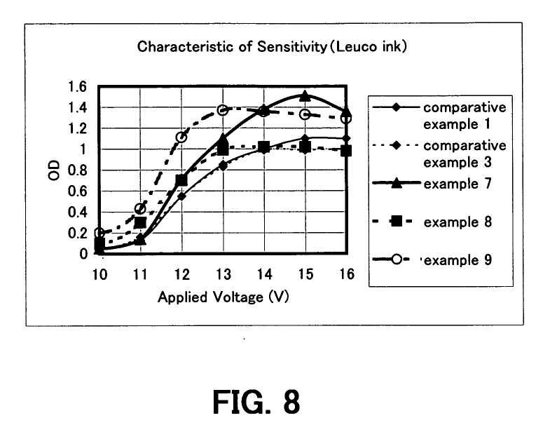

Using the thermosensitive recording medium 1 produced in this example 7, coloring sensitivity and color density of thermosensitive coloring layer 4b were measured as in examples 1 through 6. The measurements result is shown in FIG. 8. In this example, comparing to the medium sample in comparative example 3 that will be described later, the saturation density improved by some 0.4 as in example 1 and 4, while the development starting voltage did not change so much. The reason for this is considered to be same as in examples 1 and 4.

### Example 8

Thermosensitive recording medium 1 in this example is the same as example 5 except for a structure of thermosensitive coloring layers 4, that is, the first water-dispersion thermosensitive ink. Print of first water-dispersion thermosensitive ink, that is, the thermosensitive coloring layers 4 in this example is the same as in example 7.

In this example 8, thermosensitive recording medium 1 was produced such that, first, thermosensitive coloring layers 4 were formed such that the first water-dispersion inks described in example 7 were printed on ink receptive layer 3 described in example 5 using a simplified photogravure printing machine (K Printing Proofer, available from Matsuo Sangyo Co., Ltd.), equipped with an etched plate having 175 lines in cell density and 34 μm in cell depth; next, auxiliary coloring layer 5 was formed over the above-mentioned layers by printing the same second water-dispersion thermosensitive ink as in example 5, using a simplified photogravure printing machine (K Printing Proofer, available from Matsuo Sangyo Co., Ltd.), equipped with an etched plate having 175 lines in cell density and 34 μm in cell depth; then, a protective layer was formed over the auxiliary coloring layer 5 by coating OCA-5, manufactured by Nippon Kayaku Co., Ltd., over the layer with a bar coater in such an amount that the coating after dried would weigh 1 g/m². After images were recorded as shown in FIG. 5 on this medium sample using a barcode printer KP-50 of Toshiba Tec K. K., the recordings appeared without causing irregular color density in the recorded part.

Using the thermosensitive recording medium 1 produced in this example 8, coloring sensitivity and color density of thermosensitive coloring layer 4b were measured as in examples 1 through 7. The measurements result is shown in FIG. 8. As to the medium in this example, comparing to one in comparative example 3 (described later), the coloring sensitivity improved to a degree that the same degree of coloring density was obtained even if the voltage applied to the thermal printhead was lowered by some 0.5 to 1 volt. The reason for this is considered to be same as in examples 2 and 5.

### Example 9

Thermosensitive recording medium 1 in this example 9 is the same as example 6 except for a structure of thermosensitive coloring layers 4, that is, the structure of the first water-dispersion thermosensitive ink, while printing of the first water-dispersion thermosensitive ink, that is, thermosensitive coloring layers 4 in this example is the same as that of example 7.

In this example 9, a thermosensitive recording medium 1 was produced such that, first, thermosensitive coloring layers 4 were formed such that the first water-dispersion inks described in example 7 were printed on ink receptive layer 3 described in example 6 using a simplified photogravure printing machine (K Printing Proofer, available from Matsuo Sangyo Co., Ltd.), equipped with an etched plate having 175 lines in cell density and 34 μm in cell depth; next, auxiliary coloring layer 5 was formed over the above-mentioned layers by printing the same second water-dispersion thermosensitive ink as in example 6, using a simplified photogravure printing machine (K Printing Proofer, available from Matsuo Sangyo Co., Ltd.), equipped with an etched plate having 175 lines in cell density and 34 μm in cell depth; then, a protective layer was formed over the auxiliary coloring layer 5 by coating OCA-5, manufactured by Nippon Kayaku Co., Ltd., over the layer with a bar coater in such an amount that the coating after dried would weigh 1 g/m². After images were recorded as shown in FIG. 5 on this medium sample using a barcode printer KP-50 of Toshiba Tec K. K., the recordings appeared without causing irregular color density in the recorded part.

Using the thermosensitive recording medium 1 produced in this example 9, coloring sensitivity and color density of thermosensitive coloring layer 4b were measured as in examples 1 through 8. The measurements result is shown in FIG. 8. In this example, comparing to the medium sample in comparative example 3 (described later), the coloring sensitivity improved to a degree that the same degree of coloring density was obtained even if the voltage applied to the thermal printhead was lowered by some 2 volts, and the saturation density also improved by some 0.4. The reason for this is considered to be same as in examples 3 and 6.

### Comparative Example 3

This comparative example used a thermosensitive recording medium which was not provided with auxiliary coloring layer 5 in the thermosensitive recording medium 1 in example 7 (or examples 8, 9). That is, this is an example in which the second water-dispersion thermosensitive ink was not printed. Using the thermosensitive recording medium produced in this comparative example 3, coloring sensitivity and color density of thermosensitive coloring layer 4b (black) were measured as in examples 7 through 9. The measurements result is shown in FIG. 8. It can be seen that the thermosensitive recording medium in this comparative example 3 exhibited inferior than those in examples 7 through 9 either in coloring sensitivity or color density.

Although a developer was added in the ink receptive layer 3 in examples 7 through 9, addition of the developer may be omitted for examples 7 and 9. Even when the developer was omitted in examples 7 and 9, the mediums showed superior in coloring characteristics (coloring sensitivity and color density) than that in comparative example 3 by virtue of the developer added in the auxiliary coloring layer 5. This indicates that addition of the developer to the auxiliary coloring layer 5 works more effectively than its addition to the ink receptive layer 3.

<Evaluation>

Measurements of coloring sensitivity and coloring sensitivity in the mediums produced in the above examples and comparative examples were made under conditions described below:

Printer Used and Recording Condition:

| | |
|---|---|
| Thermal printhead: | type KBE-56-8 MGK1 (200 dpi), manufactured by |
| | Kyocera Corp. |
| Resistance: | 1213 ohms |
| Recording period: | 5 msec/line |
| Energized time: | 3.5 msec (at printing duty of 70%) |
| Voltages applied: | 10 to 16 volts (0.288 to 0.738 mJ/dot) |

Note:
In order to let distinct effects of the auxiliary coloring layer show, the impressions of the printhead to the media throughout the evaluation tests was set weaker than in normal recordings. For this reason, the tests were made raising the applied energy by some degree.

Test Method and Results:

Printed samples were subjected to measurement of O.D. value (color density) by Macbeth reflection densitometer type RD-19, and the measurements were plotted on graphs in FIGS. 6 through 8, and studied.

For example, when same 15 volts were applied, some voids appeared in the medium sample produced in comparative example 1, whereas such voids could hardly be recognized in all of the examples by the provision of the auxiliary coloring layer 5, and the medium has reached a practical level. It can be understood that by thus enhancing coloring sensitivity and color density, problems such as voids can be diminished even under the same printing condition.

It is seen that when thermosensitive coloring layer 4 is formed only on a surface of substrate 2 using the printing method, “streaking” likely occurs. If ink receptive layer 3 is provided in attempt to reduce this “streaking,” coloring sensitivity and recording density are lowered. However, this deterioration of coloring sensitivity and recording density can be prevented by providing auxiliary coloring layer 5.

According to the method of a thermosensitive recording medium of the present invention, thermosensitive coloring layers 4a, 4b, and 4c having two or more colors can be formed without laminating the layers on one plane, and the thermosensitive coloring layers 4a, 4b, 4c, and auxiliary coloring layer 5 can be formed by consecutively printing the first water-dispersion thermosensitive ink and second water-dispersion thermosensitive ink using the same printing method. This means that such formation can be achieved using a single printing apparatus that permits plural colors printing (herein, a gravure printing machine). That is, it has become possible that, after thermosensitive coloring layers 4a, 4b, and 4c are formed by printing the first water-dispersion thermosensitive inks that enable plural colors printing, auxiliary coloring layer 5 is formed by consecutively printing the second water-dispersion thermosensitive ink, using a single printing apparatus.

In production of a thermosensitive recording medium, in view of the need of sufficient coloring density a printing method that permits coating of much of ink is desirable. Since gravure printing is a suitable method for manufacturing a thermosensitive recording medium, it permits coating of much of ink and use of a roll paper (continuous paper) and produces high quality printing.

Conventionally, whereas production of a thermosensitive recording medium has been staged in three steps of coating, printing, and coating, this invention has simplified the production process into two steps of coating and printing. By this simplification of the production process, a production cost of a thermosensitive recording medium that develops different colors can be reduced.

Numerous modifications and variations of the present invention are possible in light of the above teachings. It is therefore to be understood that, within the scope of the appended claims, the present invention can be practiced in a manner other than as specifically described therein.

1. A method of manufacturing a thermosensitive recording medium, comprising the steps of:
preparing a substrate having an ink receptive layer;
preparing a first water-dispersion thermosensitive ink which is produced by dispersing a pigment containing at least an electron-donating compound in water;
preparing a second water-dispersion thermosensitive ink that contains one or both of an electron-accepting compound and a sensitizer that enhances thermo-sensitivity;
printing the first water-dispersion thermosensitive ink on the ink receptive layer using a predetermined printing method that uses a printing plate to impregnate the first water-dispersion thermosensitive ink into the ink receptive layer; and
printing by the predetermined printing method the second water-dispersion thermosensitive ink on the ink receptive layer on which the first water-dispersion thermosensitive ink is printed.

2. A method of manufacturing a thermosensitive recording medium according to claim 1, wherein the predetermined printing method is gravure printing method.
